(19) United States
(12) Patent Application Publication
(10) Pub. No.: US 2020/0372484 A1
(43) Pub. Date: Nov. 26, 2020

(54) COMPUTING SYSTEM FOR SHARING NETWORKS PROVIDING PAYMENT ALLOCATION BASED UPON DISTRIBUTED RESERVING AND RELATED METHODS

(71) Applicant: SHARABLE, LLC, Melbourne, FL (US)

(72) Inventor: ANTHONY F. MEGGS, MELBOURNE, FL (US)

(21) Appl. No.: 16/918,727

(22) Filed: Jul. 1, 2020

Related U.S. Application Data
(63) Continuation-in-part of application No. 16/876,736, filed on May 18, 2020.
(60) Provisional application No. 62/851,298, filed on May 22, 2019.
(60) Provisional application No. 62/851,395, filed on May 22, 2019.
(60) Provisional application No. 62/851,321, filed on May 22, 2019.
(60) Provisional application No. 62/851,279, filed on May 22, 2019.
(60) Provisional application No. 62/869,661, filed on Jul. 2, 2019.
(60) Provisional application No. 62/851,282, filed on May 22, 2019.

(51) Int. Cl. G06Q 20/14; G06Q 30/04; G06Q 20/22

(52) U.S. Cl. CPC G06Q 20/14; G06Q 20/29; G06Q 30/04

(57) ABSTRACT

A computing device may include a memory and a processor configured to cooperate with the memory to establish member share accounts for respective members of a virtual share exchange (VSE) for sharing payment of member healthcare bills across the member share accounts, and provider accounts for healthcare providers issuing the member healthcare bills. The processor may further store share deposits for the members in the member share accounts along with time stamps of the share deposits, receive member healthcare bills issued by medical providers and process the member healthcare bills for payment in chronological order by transferring funds from the different member share accounts in an alternating fashion to the provider accounts based upon the stored time stamps for the deposits, and generate a graphical user interface (GUI) displaying member share account balances aggregated across the member share accounts in real time as the member healthcare bills are processed.

### CROSS-REFERENCE TO RELATED APPLICATIONS

This application is a continuation-in-part of U.S. application Ser. No. 16/876,736 filed May 18, 2020, which claims the benefit of provisional application Nos. 62/851,282; 62/851,279; 62/851,298; 62/851,395; 62/851,321 filed May 22, 2019, and provisional application No. 62/869,661 filed Jul. 2, 2019, all of which are hereby incorporated herein in their entireties by reference.

### TECHNICAL FIELD

The present invention relates generally to computing systems and, more particularly, to computer infrastructures that provide for implementation of Virtual Share Exchange (VSE) platforms.

### BACKGROUND

In recent years, health care expense sharing has emerged as a “decentralized” approach to financing and reserving for health care costs. As a “non-insurance” alternative, health care sharing is not subject to typical insurance regulations. Individual participants are legally and ultimately responsible for their own medical bills. However, participants in health care sharing networks willingly and consistently share from their own personal funds to pay each other's medical bills.

Some health care sharing networks implement a technology framework often called a Virtual Share Exchange (VSE). The VSE may include a collection of virtual account management, billing, and payment technologies that form a comprehensive and transparent health care sharing process. The VSE model enables health care sharing networks to facilitate sharing programs on a P2P (or member-to-member) basis to help provide compliance with applicable safe harbor exemptions to insurance regulations.

VSE platforms have enabled healthcare sharing networks to rapidly grow and scale similar to institutional computer network models, like health insurance. Modern VSE platforms have become advanced Fintech applications that integrate all the stakeholders and financial processes that are necessary to facilitate member-to-member sharing via computer networking and electronic payment infrastructure.

### SUMMARY

A computing device may include a memory and a processor configured to cooperate with the memory to establish member share accounts for respective members of a virtual share exchange (VSE) for sharing payment of member healthcare bills across the member share accounts, and provider accounts for healthcare providers issuing the member healthcare bills. The processor may further store share deposits for the members in the member share accounts along with time stamps of the share deposits, receive member healthcare bills issued by medical providers and process the member healthcare bills for payment in chronological order by transferring funds from the different member share accounts in an alternating fashion to the provider accounts based upon the stored time stamps for the deposits, and generate a graphical user interface (GUI) displaying member share account balances aggregated across the member share accounts in real time as the member healthcare bills are processed.

In an example embodiment, the processor may be further configured to generate the GUI to display member share account balances for individual member share accounts in real time as the member healthcare bills are processed. The processor may further be configured to process the member healthcare bills for payment in chronological order of dates of service associated with the member healthcare bills, for example. In accordance with another example, the processor may be configured to calculate a total of reserve funds available for the VSE across all of the member share accounts based upon unrestricted funds in the member share accounts and pending received member healthcare bills.

In still another example, the processor may be further configured to prohibit transferring of member share account funds deposited in a given month for payment of a member healthcare bill until all member share account deposits from any proceeding months have been extinguished. The processor may also be configured to generate the GUI to display unused funds in the member share accounts grouped by month based upon the time stamp of deposit. In an example embodiment, the processor is further configured to calculate and bill the share deposits by month having a collective total higher than an average monthly amount of received member healthcare bills.

A related method is for using a computing device, such as the one described briefly above. The method may include establishing, at the computing device, member share accounts for respective members of a VSE for sharing payment of member healthcare bills across the member share accounts, and provider accounts for healthcare providers issuing the member healthcare bills. The method may further include, at the computing device, storing share deposits for the members in the member share accounts along with time stamps of the share deposits, receiving member healthcare bills issued by medical providers and processing the member healthcare bills for payment in chronological order by transferring funds from the different member share accounts in an alternating fashion to the provider accounts based upon the stored time stamps for the deposits, and generating a GUI displaying member share account balances aggregated across the member share accounts in real time as the member healthcare bills are processed.

A related non-transitory computer-readable medium having computer-executable instructions for causing a computing device, such as the one described briefly above, to perform various steps. The steps may include establishing member share accounts for respective members of a VSE for sharing payment of member healthcare bills across the member share accounts and provider accounts for healthcare providers issuing the member healthcare bills, storing share deposits for the members in the member share accounts along with time stamps of the share deposits, receiving member healthcare bills issued by medical providers and processing the member healthcare bills for payment in chronological order by transferring funds from the different member share accounts in an alternating fashion to the provider accounts based upon the stored time stamps for the deposits, and generating a GUI displaying member share account balances aggregated across the member share accounts in real time as the member healthcare bills are processed.

### BRIEF DESCRIPTION OF THE DRAWINGS

FIG. 1 is a schematic block diagram of a computing device for implementing a virtual share exchange (VSE) computing platform in an example embodiment.

FIGS. 2 and 3 are display views of a graphical user interface (GUI) which may be generated by the computing device of FIG. 1 and providing individual household and overall community account information, respectively, for a VSE.

FIG. 4 is a flow diagram illustrating example method aspects associated with the system of FIG. 1.

FIG. 5 is a schematic block diagram illustrating an example implementation of the computing device of FIG. 1.

FIG. 6 is a flow diagram illustrating method aspects associated with the system of FIG. 5.

### BRIEF DESCRIPTION OF THE DRAWINGS

Example embodiments will now be described more fully hereinafter with reference to the accompanying drawings, in which the example embodiments are shown. The embodiments may, however, be implemented in many different forms and should not be construed as limited to the specific examples set forth herein. Rather, these embodiments are provided so that this disclosure will be thorough and complete. Like numbers refer to like elements throughout.

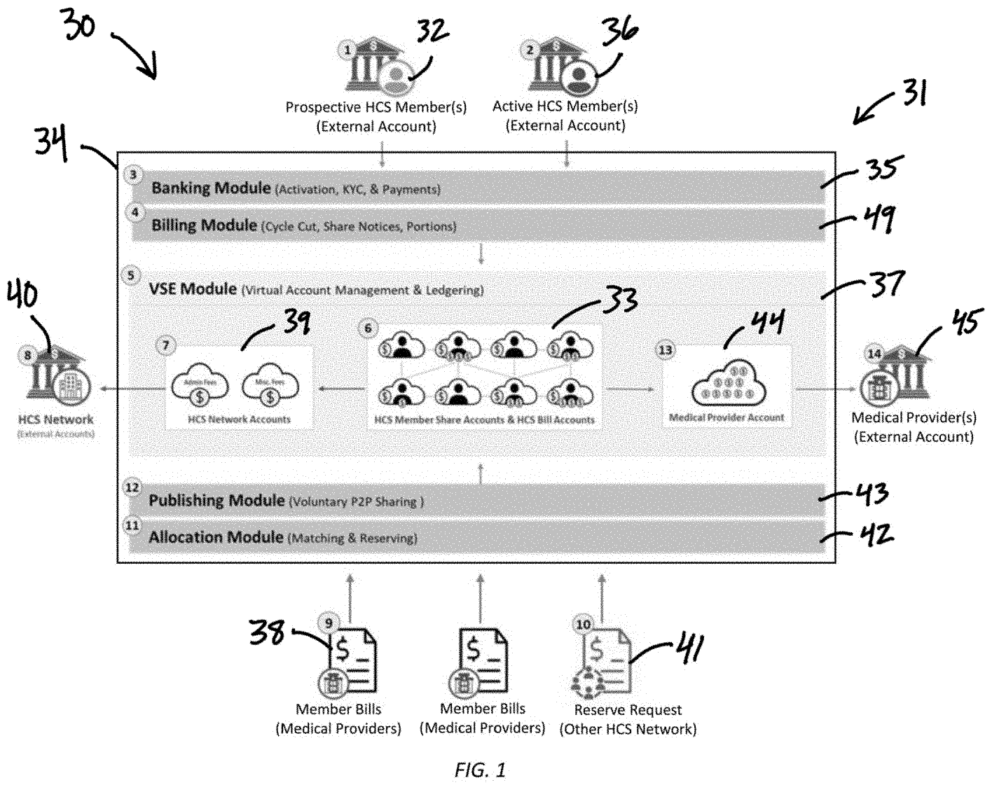

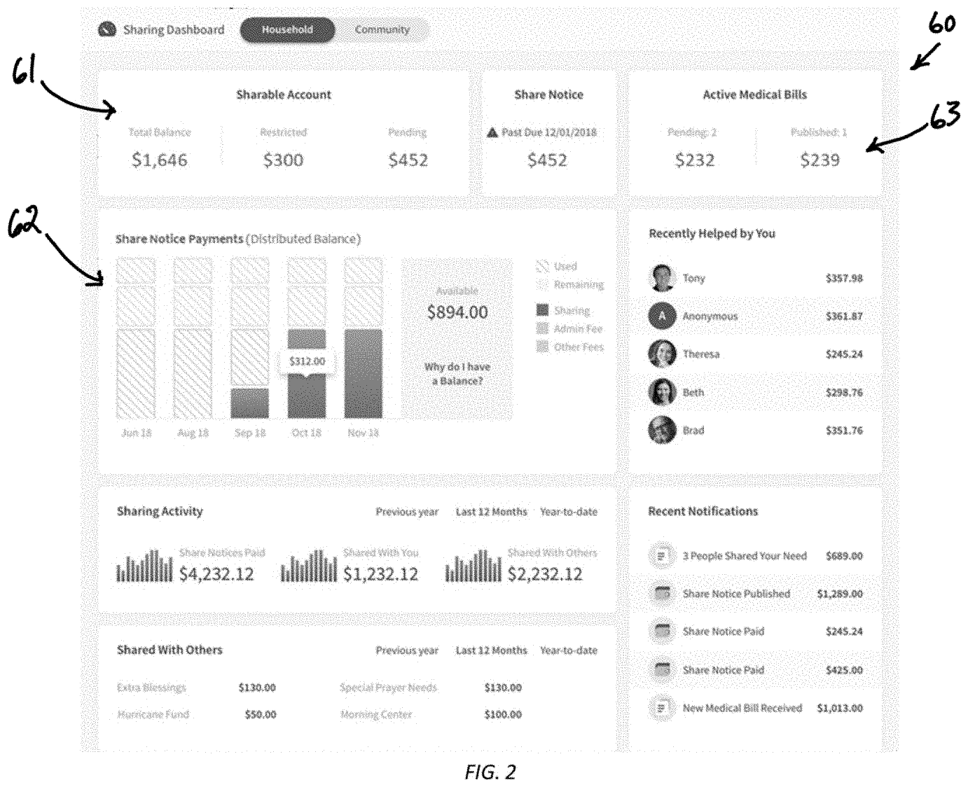

Referring initially to FIGS. 1-2, a VSE 30 implemented using a VSE platform 31 implemented via a computing device (e.g., server) 34 which provides for payment sharing within a virtual share exchange (VSE) platform 31 based upon similarities of member attributes is first described. By way of background, individuals joining forces as a group to achieve certain benefits and advantages is common in many facets of our everyday life. The power of groups is largely evident in the pooling practice found in the traditional insurance model. By pooling their resources through a centralized insurance company or common fund, groups are able to finance, reserve, and pay the expenses associated with the type of insurance risk. Without being able to rely on the insurance company and its practice of pooling funds, the individuals would be left to bear the cost and risk of a catastrophic loss by themselves.

Historically, traditional insurance companies were largely successful at helping groups of individuals finance and reserve for their expenses and catastrophic risk. By collecting and pooling both the risk and the resources of individuals into centralized group fund, traditional insurance coverage and the benefits obtained therefrom were made more affordable. In the past, the efficiency of pooling and reserving resources in a centralized fund enabled insurance companies to not only provide affordable coverage, but to capture a profit or bounty for pooling those resources into a central fund. Resources that are collected and pooled into the centralized fund are called “premiums”, which is derived from the Latin word “praemium” and defined as a “reward, profit or bounty for a specified act”. Thus, insurance companies were able to generate significant profit by extracting a “premium” from groups of individuals who were unable to pool resources to finance and reserve for their individual risk of catastrophic loss and costs.

Traditionally, the affordability of insurance coverage was predicated upon the overall wellness of the group and their consumption of services. For example, in healthcare, some members' need for medical services could be little more than annual checkups, while other individuals might need to access and consume services much more extensively. It is the latter group that has a greater effect on the overall costs of the group and the subsequent premiums collected. For those that do not frequently draw upon the centralized fund's resources, being lumped with the more extensive users is unfavorable. On the flip side, those who consume a larger share of the benefits may enjoy lower premiums because the individuals that consume little are subsidizing the expense of frequent consumers. In the past, insurance companies would respond to individuals who draw disproportionally on the centralized fund by raising their premiums to maintain group equity and ensure company profits.

With respect to financing and reserving for health care, the average consumer would not be able to afford much more than the very basic of health care services if the pooling of resources was not available through insurance. In fact, based upon current rates being charged by the medical industry, cutting edge or life-saving surgeries, drugs and treatments would be difficult, if not, impossible, for the average consumer to obtain.

However, in recent years the affordability and profitability of the traditional insurance model has been degraded by the enactment of government regulations. New laws and regulations have all but eliminated an insurance company's ability to segment groups of healthy individuals into centralized funds, or plans, that price premiums according to the group's health and draw on resources. Similarly, new regulations have mandated that all centralized funds, or plans, cover new and more extensive medical services not historically offered by health insurance companies. As a result, health insurance companies have been greatly limited in their ability to offer affordable coverage that is reflective of the health condition and medical usage of individual participants, as well offer affordable plans that provide access to the medical services that participants actually desire, versus services the government mandates.

Another disadvantage of the health insurance model and the associated regulations is that individuals of the centralized fund and plan can lead unhealthy or “at risk” lifestyles such as high-risk diets, low exercise, smoking, excessive alcohol intake and the use of illicit drugs, all without consequence. By engaging in such lifestyles, these individuals increase their likelihood of drawing on the resources and benefits of the centralized fund. The more these “high-risk” individuals are allowed to make choices and lead lives without consequences, the more likely that costs and premiums increase for everyone in the fund.

An additional disadvantage of the centralized insurance model is that the plan benefits are distributed to individuals of the group in such a way that no other individual participating in the plan has any real sense of what types of benefits or services are being paid for by the insurance company. The centralized insurance model provides no visibility into the size of the fund, the number of participating individuals, the size of available reserves, the flows of money, or profits pocketed by the insurance company. Thus, participating individuals are unaware of the financial health and wellness of the fund. This lack of transparency also makes individuals feel less responsible for their lifestyle choices that increase their draw of resources, as well as less connected and accountable to their fellow participants who are paying their bills.

The structural inefficiencies, inherent in the design of the centralized health insurance model, have been recently exposed by the new government mandates and regulations in health care. It has caused a rapid and unsustainable rise in premiums and insurance costs. Thus, the centralized health insurance model has become unaffordable and subsequently obsolete. And while the changes have been focused exclusively on healthcare, the aforementioned problems similarly persist in the other insurance markets.

As a result, consumers have sought out new and more innovative ways to organize themselves into groups that leverage the strength of their combined resources to finance and reserve for their health care costs. Unlike the centralized insurance model, consumers are turning to decentralized network models that are enabled by technologies that replace the pooling functions of traditional insurance companies.

In recent years, health care sharing has emerged as the most popular “decentralized” approach to financing and reserving for health care costs. As a “non-insurance” concept, health care sharing is not encumbered by insurance regulations. Individual participants are legally and ultimately responsible for their own medical bills. However, participants in health care sharing networks willingly and consistently share from their own personal funds to pay each other's medical bills. Health care sharing networks have been in existence since the early 1980s, but in recent years have grown to become a significant alternative to the centralized insurance model. Today, health care sharing networks enjoy safe harbor exemptions in U.S. health care laws and more than 30 states. Participants of health care sharing networks are sharing billions of dollars worth of medical bills on an annual basis. Free from insurance regulations, health care sharing networks can design and implement programs that are more efficient and affordable than insurance, as well as hold participants more accountable to each other.

As noted above, some health care sharing networks implement a technology framework often called a Virtual Share Exchange or VSE. The VSE platform 31 set forth herein may include a collection of computing hardware (e.g., servers or other computing devices including microprocessors and associated memory with non-transitory computer readable instructions) to implement virtual account management, billing, and payment modules that form a comprehensive and transparent health care sharing process. The VSE model enables health care sharing networks to facilitate sharing programs on a P2P (or member-to-member) basis to help ensure that these sharing networks refrain from the practice of insurance, and remain in compliance with the safe harbor exemptions of insurance rules/regulations.

Moreover, contemporary VSE platforms 31 have enabled healthcare sharing networks to rapidly grow and scale their networks by leveraging social trends towards the democratization of centralized institutional business models, like health insurance. Modern VSE platforms 31 have become advanced Fintech applications that integrate all the stakeholders and financial processes that facilitate member-to-member sharing.

Prospective members 32 are consumers who are applying for membership into the sharing network and its community. In order to complete their application for membership, prospective members 32 setup and activate their share account 33 through a computing device(s) 34, such as a server. In an example embodiment, the computing device 34 may be part of a cloud computing architecture, although other configurations may be used in different embodiments. Share or sharing accounts 33 are activated through a graphical user interface or GUI (often called the Application Center or Activation Center) to access account activation services within a banking module 35 of the computing device 34.

Active members 36 are consumers who have been accepted and are active in the sharing network and associated community. Active members 36 make monthly deposits (called monthly share amounts) electronically into their share account 33 that is held within a VSE/for the benefit of (FBO) module 37 of the computing device 34. To pay (or deposit) their monthly share amount into their share account 33, members 36 access services within the banking module 35 through a graphical user interface 60, as will be discussed further below. The banking module 35 provides services that enable members 36 to link their share account 33 to an external payment method and initiate recurring monthly transactions.

The banking module 35 may be implemented as a cloud-based application that enables both prospective members 32 and active members 36 to activate and manage their participation in the sharing network's program through a financial account (called a share account 33) that the member owns and controls. The banking module 35 enables members 36 to link an external bank account to their share account 33, to fund their share account per the terms of the sharing network, and to manage banking and regulatory compliance.

The billing module 49 may be implemented as a cloud-based application that calculates monthly share prices and creates the monthly share notices for the sharing network. Moreover, the billing module bills, publishes and collects the monthly share notice per the terms of the sharing network.

The VSE/FBO module 37 may also be implemented as a cloud based virtual account management and ledgering system that enables the sharing network to facilitate the member-to-member sharing and payment of member bills. The VSE/FBO module 37 enables member-to-member sharing through virtual accounts 33 that are owned and individually controlled by the members 36 and not the sharing network, as well as to house those virtual accounts in a single FBO account held by a financial institution “for the benefit of” the member 36.

The member share accounts 33 are member owned and controlled virtual accounts maintained by the VSE/FBO module 37, and are required for members 36 to participate in the sharing network. The share accounts 33 enable the sharing network to build distributed reserves in accounts that are owned and controlled by its members 36, and facilitate member-to-member sharing through those accounts.

Sharing network fee accounts 39 are virtual accounts maintained by the VSE/FBO module 37 that are owned and controlled by the sharing network and used to comply with any potential regulatory constraints. The fee accounts 39 help segregate “member owned” funds that are held in share accounts 33 and used for sharing from “network owned” funds, which are operating fees that are billed and collected as a part of a monthly share notice.

Sharing network external accounts 40 are external bank accounts that are owned and controlled by the sharing network and are linked to a specific sharing network fee account 39 that resides in the VSE/FBO module 37. As operating fees are collected through the payment by members 36 of monthly share notices, sharing networks are able to access those funds by transferring them out of the sharing network fee account 39 to its linked external account 40. The sharing network external accounts 40 allow for withdrawing operating funds out of the VSE/FBO module 37.

The member bills 38 are invoices billed by a member's service provider that have been received by the sharing network. The member bills 38 are to be shared by the members of the sharing network per the network's guidelines.

A sharing reserve request 41 represents a member bill from another sharing network that is participating in a federation or collaboration of sharing networks who have agreed to share in each other's member bills per the terms of a shared reserve agreement. Further details regarding sharing reserve requests are set forth in co-pending U.S. application Ser. No. 15/931,786 filed May 14, 2020, which is hereby incorporated herein in its entirety by reference.

An allocation module 42 may be implemented as a cloud-based bill matching and allocation service enabling sharing networks to facilitate bill sharing, help ensure regulatory compliance, and to generate more meaningful sharing transactions. The allocation module 42 may be used to match and allocate bills on a member-to-member basis, and to draw down distributed bills in a way that is equitable to all members 36.

A publishing module 43 may be implemented as a cloud-based notification and sharing service for initiating member-to-member (P2P) account transfers. The publishing module 43 notifies members 36 as to whose bill they have been matched to, and how much of their available share account 33 balance has been allocated as a contribution to the payment that member's bill, as well as to provide each matched member with the means to voluntarily share (agree) in the payment of that bill.

The provider account 44 is a virtual account within the VSE module 37 that is owned and managed by individual service providers, or a single virtual “settlement” account that aggregates funds for multiple payments made to multiple service providers, or some combination of both. The provider account(s) 44 segregate funds that have been shared and collected for the payment of a bill 38 or 41, and to make those funds available to the appropriate service provider.

An external provider account 45 is a linked external account owned and managed by an individual service provider for transferring funds out of the VSE/FBO module 37 or linked external account owned and managed by a payment processor for transferring multiple payments to be made to multiple service providers. More particularly, the provider external accounts 45 allow for withdrawing bill 38, 41 payments out of the VSE/FBO module 37.

In order to maintain a status as a non-insurance entity, many states oblige healthcare sharing networks to exclusively practice a member-to-member (or peer-to-peer) transfer of funds versus pooling or holding funds in an aggregated reserve or escrow account. Through the modernization of technologies that allow paperless account-to-account financial transactions, healthcare sharing networks can implement a peer-to-peer (member-to-member) sharing methodology by transferring funds directly between member accounts. By adopting an account-to-account method to satisfy regulatory statutes that require member-to-member sharing, sharing networks are able to clearly demarcate themselves from the practice of insurance, while at the same time enabling themselves to build and sustain reserves that equal the fiscal soundness of the insurance model.

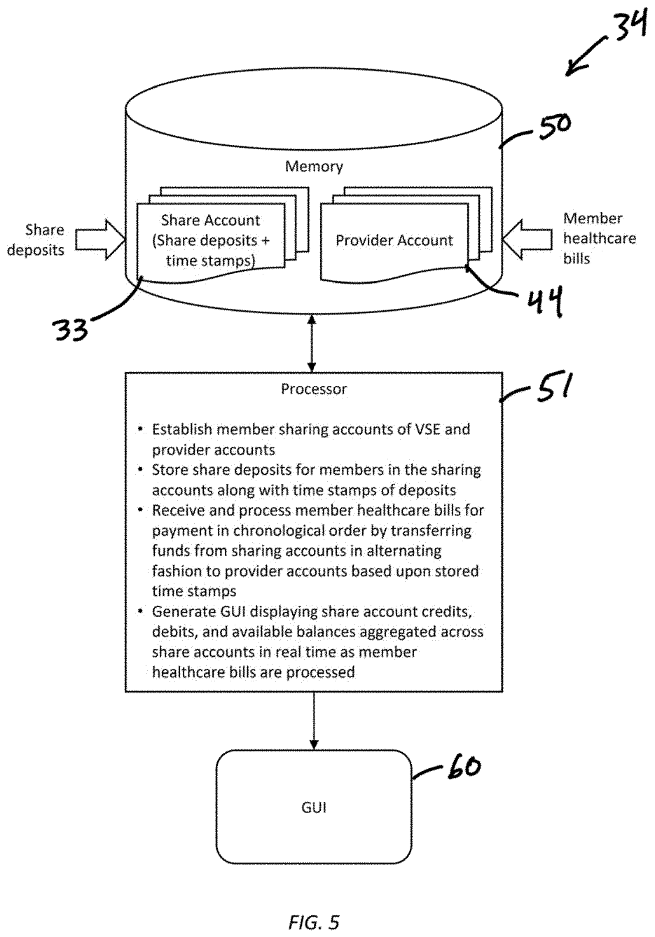

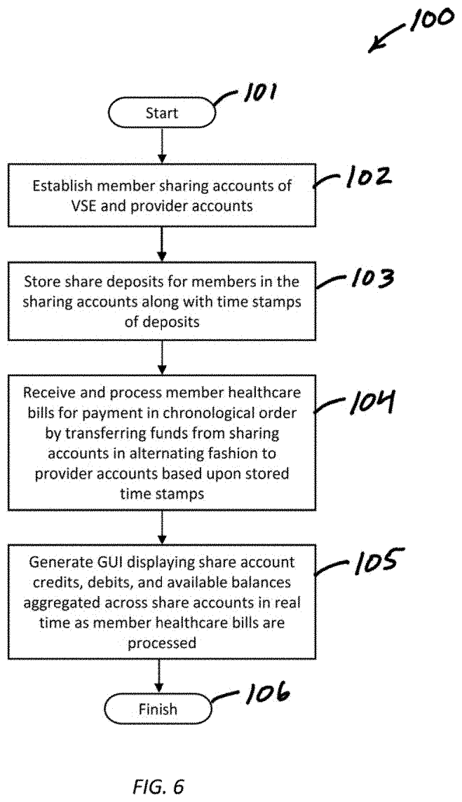

Referring to FIG. 5 and the flow diagram 100 of FIG. 6, an example embodiment of the computing device 34 is now described which illustratively includes a memory 50 and a processor 51 configured to cooperate with the memory to perform the operations or steps described herein. Beginning at Block 101, the processor 51 establishes member sharing accounts 33 for respective members 36 of the VSE 30 for sharing payment of member healthcare bills 38 (including, optionally, reserve requests 41) across the member sharing accounts, and provider accounts 44 for healthcare providers 45 issuing the member healthcare bills, as discussed above (Block 102). The processor 51 may further store share deposits for the members 36 in the sharing accounts 33 along with time stamps of the share deposits, at Block 103, and receive member healthcare bills 38 issued by medical providers 45. The processor 51 further processes the member healthcare bills 38 for payment in chronological order by transferring funds from the different sharing accounts 33 in an alternating fashion to the provider accounts 44 based upon the stored time stamps for the deposits, at Block 104, and generates a GUI 60 displaying share account credits, debits, and/or available balances individually or aggregated across the share accounts in real time as the member healthcare bills are processed, at Block 105, as will be discussed further below. The method of FIG. 6 illustratively concludes at Block 106.

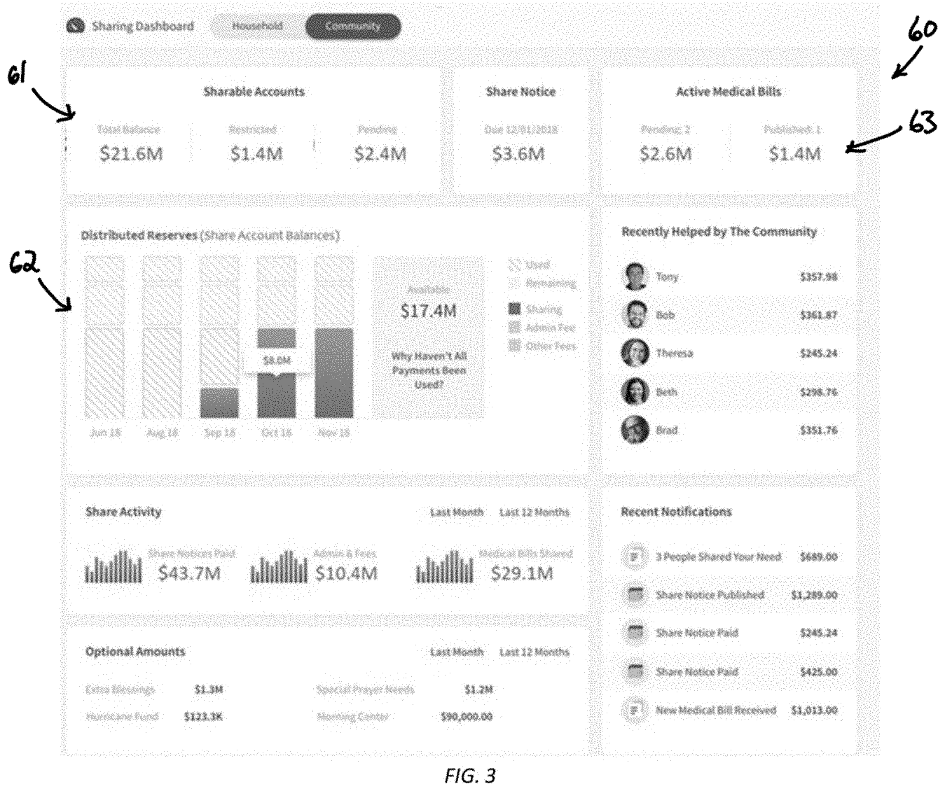

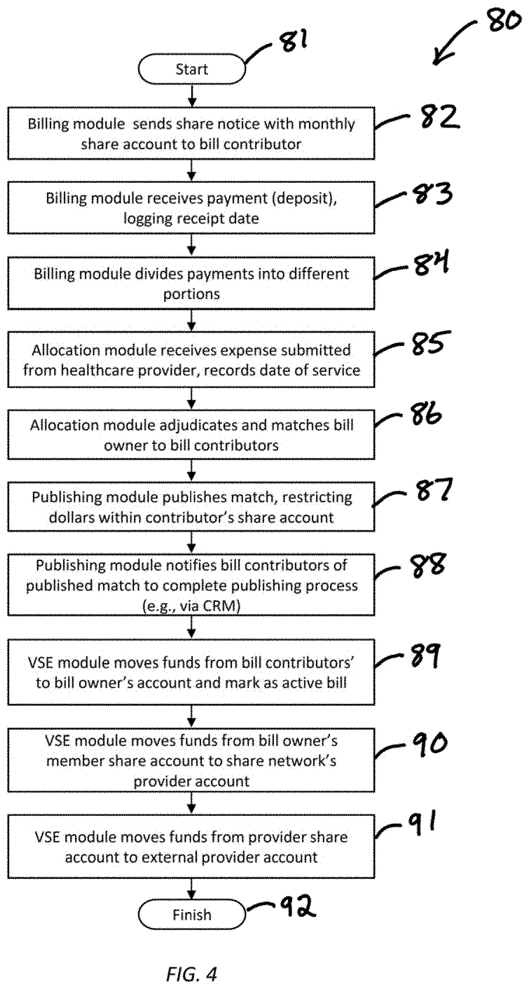

Referring now additionally to FIGS. 2-3 and the flow diagram 80 of FIG. 4, an example implementation of the VSE platform 31 is now described which advantageously allows sharing networks to execute a sharing model that gives members control over their personal funds which are electronically stored within their VSE share accounts 33 until such a time the funds are utilized for another member's healthcare needs. This approach helps ensure an equitable draw on member accounts by prioritizing a use of funds that matches and allocates the oldest monies received to oldest bills by service date. Thus, the VSE 34 will order and display, by default, the distribution of unutilized funds (i.e., available balances) by month of funds received. As funds go unutilized, they remain in the member-controlled share account 33 within the VSE 34, which effectively builds a type of “reserve” for the benefit of the members of the network.

A VSE graphical user interface (GUI) 60 displays a detailed accounting of the member's share account 33 including each instance of their deposited funds via share notice payments, as well as any transfers to other members 36 for the purpose of sharing. These account activities and any remaining balances are marked, distributed and displayed by month in every member account. The GUI 60 also displays an accounting and distribution of all member balances, at an aggregate level, in order to provide the necessary transparency to satisfy regulatory statutes. Yet, this is done while giving the members of the network a clear view and confidence into the number of medical reserve months held in member accounts 33.

In accordance with the present example, the VSE platform 31 advantageously invoices and collect funds, holds the collected funds in specified accounts, and matches and allocates the oldest funds with the oldest bill in a manner that prevents the sharing network from taking receipt of or otherwise pooling the funds. Beginning at Block 81, members 36 in the share network 40 may make contributions on a recurring basis, most commonly on a monthly basis. The billing module 49 sends members 36 a notice (Block 82), which is also referred to as a “share notice”, of their monthly share amount. The monthly share amount may be determined by aggregating the individual line items, or “portions”, as determined by the program the member 36 is participating in. In the illustrated example, as payments for the monthly share notices are received (Block 83), the billing module 49 divides the payments into two different portions, at Block 84. A first portion is for sharing in the approved medical needs of other members 36, and the second is for the general administrative fees and services to facilitate the program.

The monthly share amount funds may be remitted by the member 36 via the VSE's banking module 35. As the funds come into the VSE platform 31, they appear on the member's GUI portal 60. Through an integration with the VSE's billing module 49, the banking module 35 automatically moves the appropriate amount of funds into distinct, corresponding virtual accounts as indicated. For the funds related to the portion for administrative fees and services, they are moved to a corresponding share network account 39. Funds held in the share network accounts 39 are owned and managed by the sharing network 40 and may be withdrawn from the VSE platform 31 into an external account at any point by the sharing network.

Funds related to the portion for sharing approved medical bills are held in individually owned member shared accounts 33 within the VSE module 37. While these member share accounts 33 are indeed owned and controlled by the members 36, the member permits the share network 40 to move funds in and out as needed for the purpose of sharing approved medical bills. During the normal course of operations, it is common for there to be more available funds within the member share accounts 33 across the entire VSE platform 31 than what is needed immediately for approved medical bills. Therefore, the surplus stays within these individual member share accounts 33 that are owned and controlled by the individual members 36. That surplus effectively serves as a type of “reserve”, yet is never received, held or owned by the share network 40.

This approach of having a surplus serve as a type of “reserve” maintained within the individually-owned member share accounts 33 uniquely benefits the share network 40 in a number of ways. This allows for building of reserve funds to a targeted level by establishing monthly share amounts that are greater than the actual flow of approved medical bills 38 (and/or reserve requests 41). Moreover, it allows for the distribution of the surplus into member owned accounts 33, thereby avoiding any “pooling of funds” in a centralized account (an attribute of insurance networks). Furthermore, this approach allows for the retention of the surplus while not taking receipt of the funds (another attribute of insurance networks) in the event of an influx of approved medical expenses.

As members 36 remit their monthly share amounts indicated on the monthly share notice (Block 83), the member can see the record of the payment within their member portal GUI 60. Within the member portal GUI 60, the member 36 can easily see their individual household's sharing contributions within a sharable account section 61. A share notice payments section 62 illustratively displays the total dollars that have been collected for specified portions on the monthly share notice for a given month and further clarify if a surplus exists.

In order to ensure funds can be retained for the utilization of sharing in approved medical bills 38, despite having a total balance within the share account 33, some dollars may be restricted as shown in the sharable account section ($300 of a total balance of $1,646 in the present example). Restrictions within a share account 33 may occur because the allocation module 42 has matched funds (Blocks 85-86) from a given share account 33 to be used for an eligible medical bill (or reserve request 41). Further restrictions may occur if funds have been deposited into an individual share account 33 to provide for any of the approved medical bills 38 that may be active, as shown in an active medical bill section 63 of the GUI 60, and belong to the family that owns the share account.

In FIG. 3, a community view of the GUI 60 is provided, as opposed to the household/member specific view showing FIG. 2. Here, the VSE module 37 presents data relevant to the entire community, not simply an individual. As members 36 remit their monthly share amount indicated on their individual monthly share notices, the membership as a whole can see the record of the payments within their member portal GUI 60. Within the GUI 60, the member 36 can easily see their entire community's sharing contributions. The aggregated amounts within the individual share accounts 33 may display in the section 62 the total dollars that have been collected for specified portions on the collected monthly share notices for a given month, and further clarify if a surplus exists. Moreover, displaying of the surplus in the GUI 60 may be distributed by month deposited, which ultimately indicates the number of sharing months that have been built-up by the network 40 and its community.

In order to determine which dollars within a share account 33 are to be used in paying approved medical bills 38, sharing networks 40 on the VSE platform 31 may match and allocate the oldest received dollars with the oldest approved medical bill. This approach to sharing is called FIFO Sharing, or first-in-first-out. A FIFO sharing process is executed by tagging monthly share deposits by the date they are deposited into the member share accounts 33 and tagging medical bills by the date that the service was rendered by the provider. Matching and allocation algorithms are then used to prioritize oldest deposited money against the oldest bills 38. That is, the VSE module 37 removes funds from the share accounts 33 in an alternating fashion, e.g., withdrawing available funds with the oldest time stamp from a first bill contributor's account 33, then moving to a second deposit in another bill contributor's account having the next oldest time stamp, etc.

By deploying algorithms that match and allocate funds by oldest dollars received to oldest bills 38 received, sharing networks 40 are enabled to facilitate an equitable draw of funds (available balances) that are distributed and held in member accounts 33. Moreover, because this is done in an automated fashion by the computing device 34, it can be performed in real time to maintain the equitable accounting across a large member base at all times, which would otherwise not be possible with manual accounting practices. Again, this is important in a VSE context because funds cannot be simply set aside in a pooled account as in an insurance network model, but instead need to be maintained within individual member accounts up until the time funds are shared to pay another member's healthcare bill. Yet, the computing device 34 still provides for accurate and timely monitoring and forecasting across the VSE platform 31 to ensure that overall reserve levels are met, while also allowing members a transparent view into the overall state of the VSE 30 and their respective accounts 33 at any time.

This equitable draw helps ensure that all September funds held in member accounts are matched and allocated before any October funds are drawn, for example. Thus, the FIFO sharing process enables the VSE platform 31 to distribute and display balances in the individual member account 33 by month, as well as distribute and display funds held in all member accounts on an aggregate basis by month. By distributing and displaying the aggregate member balances by month, members of the sharing network 40 can easily see the number of sharing months that have been built, reserved and held by the community of members 36.

Once the matching of funds to a bill occurs, as part of the publishing process (Blocks 87-88), the publishing module 43 restricts the dollars accordingly in the contributing member's share account 33. Each share network 40 may have its own protocol for how notification to contributing members is executed, e.g., via the share network's customer relations management (CRM) tool. Bills matched, allocated and published (i.e., notification) for sharing remain in a published state for a period of time (e.g., three days), which may be configured by the share network 40. This is called the “publishing period”. The publishing period satisfies additional regulatory requirements by giving notice of sharing before funds are transferred and allowing members to withdraw from membership before funds are transferred. Thus, the publishing of matched bills 38 and the allocated publishing period satisfies the “voluntary sharing” requirement of most regulatory statutes. After the publishing period is satisfied, the restricted funds are then moved (Block 89) into the recipient's share account 33. Those moved funds would now appear as used in the GUI 60. The moved funds are similarly restricted to the recipient and indicated as an active bill (section 63) until they are moved into the provider account 44 (Block 90), and subsequently to the medical provider's external account 45 (Block 91). The method of FIG. 4 illustratively concludes at Block 92.

The above-described distributed reserving process may accordingly dynamically calculate and bill monthly share amounts greater than the average monthly amount needed to pay medical bills. For further details, see co-pending application no. U.S. application Ser. No. 16/876,736 noted above. This enables the sharing network 40 to build reserves by collecting more than what is needed to pay the outstanding member bills 38. Furthermore, the above-described approach also allows for the collection of monthly share amounts in member owned and managed share accounts 33, and thus sharing network 40 avoids the insurance practice of “pooling” funds by not taking receipt of the funds. Instead, the VSE platform 31 builds, holds and distributes the reserves (available balances) in member owned accounts 33.

In addition, the VSE platform 31 also time stamps the deposits (monthly share amounts) by date collected and medical bills by the date of service so that the sharing network 40 can enable a FIFO sharing process, as discussed further above. By having the VSE platform 31 match and allocate medical bills by oldest money to oldest bills (FIFO), the sharing network 40 can facilitate an equitable draw on member held funds, as well as display member held funds (reserves) on a monthly basis.

Furthermore, the VSE platform 31 may also display share account 33 credits (deposits), debits, and available balances by month on an individual member level, as well as on a community level. The individual level advantageously helps members 36 to see their individual available balance distributed by month. Displaying share account credits (deposits), debits, and available balances by month on an aggregate community level allows members 36 to see the number of available “sharing” months that have been built-up and reserved, and to understand how the available balance in their individual account is used to build and retain reserves.

The VSE platform 31 uniquely accommodates the creation of member-owned and controlled financial accounts 33. By being independently owned and therefore controlled by the members 36 within the share network 40, these accounts receive the same level of insurance protection awarded to the other accounts. By leaving balances within the share accounts 33, the share network 40 is able to build and sustain reserves while never taking control or ownership of the funds.

The approach set forth herein provides a detailed view (GUI) of the member's share account 33 that clearly shows the distribution of the dollars in their account. Prior to being allocated by the VSE platform 31, the funds belong to the member, therefore it is important for the VSE platform to show the appropriate ledgering and utilization of the funds. This approach also provides a detailed view of a member's share account 33 that indicates distributed funds received and funds used by month. When the member 36 receives the share notice, the share notice indicates the portions the member previously agreed to. The GUI 60 provides confirmation that the share network 40 utilizes the contributing member's funds as intended.

The VSE platform 31 also provides a display within the member account 33 that allows the member 36 to see a detailed view of dollars available within the community as a whole. This enables the members 36 to know the dollars already being utilized for medical bills 38 (and optionally reserve requests 41), and it can also show the reserves by date received currently distributed among the entire membership.

In addition, the VSE platform 31 may use the available funds persisting in the share accounts in the order received. Once a bill is ready to be paid, the allocation module 42 will order the allocation based upon the service date of the medical procedure. This “first-in-first-out” model for both utilization of the reserves as well as the allocation of the funds provides an equitable and fair draw amongst the reserves.

As such, the VSE platform 31 advantageously enables sharing network 40 to build and sustain bill reserves (similar to insurance networks), but to do so in a way that is different from the insurance network approach to building reserves (i.e., decentralized vs. centralized), and while complying with regulatory statutes that prohibit the unlawful sale of insurance. Moreover, the VSE platform 31 also enables sharing network 40 to build and sustain bill reserves without taking receipt of member funds, as the funds are held and owned by the members 36, not the sharing network.

Moreover, the VSE platform 31 also enables the equitable draw and use of funds in the member share accounts 33, e.g., September money is used before October money is used. This also enables the sharing network 40 to build confidence from its members by distributing and displaying the number of sharing months that are being held in all the member accounts 33. This also enables visibility and transparent use of member 36 funds contributed to the VSE 30.

As noted above, the VSE platform 31 may be implemented using one or more computing devices 34 such as servers, network interface devices, client devices, etc., including the appropriate hardware (e.g., processor, memory, etc.) and software having non-transitory computer readable instructions for performing the operations discussed herein. Moreover, in some embodiments the VSE platform 31 may be implemented within a cloud computing network. As noted above, it will be appreciated that the systems and methods set forth herein may also be used with other types of cost or expense sharing platforms besides healthcare sharing networks. That is, VSE platform may also support other share networks beyond just health care sharing, such as veterinary bills, automotive or appliance repairs, etc.

Further details regarding example VSE platform 31 implementations are provided in co-pending application Ser. No. 16/881,528 (filed May 22, 2020) and Ser. No. 15/931,767 (filed May 14, 2020), which are hereby incorporated herein in their entireties by reference.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

That which is claimed is:

1. A computing device comprising:
a memory and a processor configured to cooperate with the memory to
establish member share accounts for respective members of a virtual share exchange (VSE) for sharing payment of member healthcare bills across the member share accounts, and provider accounts for healthcare providers issuing the member healthcare bills,
store share deposits for the members in the member share accounts along with time stamps of the share deposits,
receive member healthcare bills issued by medical providers and process the member healthcare bills for payment in chronological order by transferring funds from the different member share accounts in an alternating fashion to the provider accounts based upon the stored time stamps for the deposits, and
generate a graphical user interface (GUI) displaying member share account balances aggregated across the member share accounts in real time as the member healthcare bills are processed.

2. The computing device of claim 1 wherein the processor is further configured to generate the GUI to display member share account balances for individual member share accounts in real time as the member healthcare bills are processed.

3. The computing device of claim 1 wherein the processor is further configured to process the member healthcare bills for payment in chronological order of dates of service associated with the member healthcare bills.

4. The computing device of claim 1 wherein the processor is further configured to calculate a total of reserve funds available for the VSE across all of the member share accounts based upon unrestricted funds in the member share accounts and pending received member healthcare bills.

5. The computing device of claim 1 wherein the processor is further configured to prohibit transferring of member share account funds deposited in a given month for payment of a member healthcare bill until all member share account deposits from any proceeding months have been extinguished.

6. The computing device of claim 1 wherein the processor is further configured to generate the GUI to display unused funds in the member share accounts grouped by month based upon the time stamp of deposit.

7. The computing device of claim 1 wherein the processor is further configured to calculate and bill the share deposits by month having a collective total higher than an average monthly amount of received member healthcare bills.

8. A method for using a computing device comprising:
establishing, at the computing device, member share accounts for respective members of a virtual share exchange (VSE) for sharing payment of member healthcare bills across the member share accounts, and provider accounts for healthcare providers issuing the member healthcare bills;
storing, at the computing device, share deposits for the members in the member share accounts along with time stamps of the share deposits;
receiving, at the computing device, member healthcare bills issued by medical providers and processing the member healthcare bills for payment in chronological order by transferring funds from the different member share accounts in an alternating fashion to the provider accounts based upon the stored time stamps for the deposits; and
generating, at the computing device, a graphical user interface (GUI) displaying member share account balances aggregated across the member share accounts in real time as the member healthcare bills are processed.

9. The method of claim 8 wherein generating the GUI further comprises generating the GUI to display member share account credits, debits, and available balances for individual member share accounts in real time as the member healthcare bills are processed.

10. The method of claim 8 further comprising, at the computing device, processing the member healthcare bills for payment in chronological order of dates of service associated with the member healthcare bills.

11. The method of claim 8 further comprising, at the computing device, calculating a total of reserve funds available for the VSE across all of the member share accounts based upon unrestricted funds in the member share accounts and pending received member healthcare bills.

12. The method of claim 8 further comprising, at the computing device, prohibiting transferring of member share account funds deposited in a given month for payment of a member healthcare bill until all member share account deposits from any proceeding months have been extinguished.

13. The method of claim 8 wherein generating further comprises generating the GUI to display unused funds in the member share accounts grouped by month based upon the time stamp of deposit.

14. The method of claim 8 further comprising, at the computing device, calculating and billing the share deposits by month having a collective total higher than an average monthly amount of received member healthcare bills.

15. A non-transitory computer-readable medium having computer-executable instructions for causing a computing device to perform steps comprising:
establishing member share accounts for respective members of a virtual share exchange (VSE) for sharing payment of member healthcare bills across the member share accounts, and provider accounts for healthcare providers issuing the member healthcare bills;
storing share deposits for the members in the member share accounts along with time stamps of the share deposits;
receiving member healthcare bills issued by medical providers and processing the member healthcare bills for payment in chronological order by transferring funds from the different member share accounts in an alternating fashion to the provider accounts based upon the stored time stamps for the deposits; and
generating a graphical user interface (GUI) displaying member share account balances aggregated across the member share accounts in real time as the member healthcare bills are processed.

16. The non-transitory computer-readable medium of claim 15 generating the GUI further comprises generating the GUI to display member share account balances for individual member share accounts in real time as the member healthcare bills are processed.

17. The non-transitory computer-readable medium of claim 15 further having computer-executable instructions for causing the computing device to perform a step of processing the member healthcare bills for payment in chronological order of dates of service associated with the member healthcare bills.

18. The non-transitory computer-readable medium of claim 15 further having computer-executable instructions for causing the computing device to perform a step of calculating a total of reserve funds available for the VSE across all of the member share accounts based upon unrestricted funds in the member share accounts and pending received member healthcare bills.

19. The non-transitory computer-readable medium of claim 15 further having computer-executable instructions for causing the computing device to perform a step of prohibiting transferring of member share account funds deposited in a given month for payment of a member healthcare bill until all member share account deposits from any proceeding months have been extinguished.

20. The non-transitory computer-readable medium of claim 15 wherein generating further comprises generating the GUI to display unused funds in the member share accounts grouped by month based upon the time stamp of deposit.
